(19) United States
(12) Patent Application Publication
(10) Pub. No.: US 2026/0330751 A1
(43) Pub. Date: Oct. 22, 2026

(54) THREE-DIMENSIONAL (3D) RECONSTRUCTION ASSISTED 3D GAUSSIAN SPLATTING

(71) Applicant: QUALCOMM Incorporated, San Diego, CA (US)

(72) Inventors: Pirazh KHORRAMSHAHI, San Diego, CA (US); Upal MAHBUB, El Cajon, CA (US); Mehul ARORA, San Diego, CA (US); Adithya Reddy NALLABOLU, San Diego, CA (US); Gokce DANE, San Diego, CA (US)

(21) Appl. No.: 19/183,591

(22) Filed: Apr. 18, 2025

(51) Int. Cl. G06T 15/20; G06T 17/20

(52) U.S. Cl. CPC G06T 15/205; G06T 17/205

(57) ABSTRACT

Systems and techniques are described for image processing. For example, a computing device can generate, based on image sensor pose information and depth information of views of a scene, a three dimensional (3D) mesh of the scene. The computing device can initialize a Gaussian splatting model based on the 3D mesh of the scene. The Gaussian splatting model includes Gaussian splats, where each respective Gaussian splat includes respective parameters corresponding to each view of the views of the scene. The computing device can render, based on the initialized Gaussian splatting model, rendered images of the scene corresponding to one or more views of the views of the scene. The computing device can update, based on a difference between the rendered images of the scene and images of the scene captured by an image sensor, one or more parameters of the parameters of the Gaussian splatting model.

### FIELD

The present disclosure generally relates to image processing. For example, aspects of the present disclosure relate to three-dimensional (3D) reconstruction assisted 3D Gaussian splatting.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

Traditional systems for constructing 3D models use a significant amount of computational resources, memory, and bandwidth, and in some cases generate significant heat in the process. In recent decades, there has been a demand for 3D content for computer graphics, virtual reality, and communications. Recent decades have also shown a demand for performing more computing tasks on portable computing devices rather than bulky stationary computing systems.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for 3D reconstruction assisted 3D Gaussian splatting. In some aspects, an apparatus for image processing is provided. The apparatus includes at least one memory and at least one processor coupled to the at least one memory and configured to: generate, based on image sensor pose information and depth information of a plurality of views of a scene, a three dimensional (3D) mesh of the scene; initialize a Gaussian splatting model based on the 3D mesh of the scene, wherein the Gaussian splatting model includes a plurality of Gaussian splats, and wherein each respective Gaussian splat of the plurality of Gaussian splats includes a respective plurality of parameters corresponding to each view of the plurality of views of the scene; render, based on the initialized Gaussian splatting model, a plurality of rendered images of the scene corresponding to one or more views of the plurality of views of the scene; and update, based on a difference between the plurality of rendered images of the scene and a plurality of images of the scene, one or more parameters of the plurality of parameters of the Gaussian splatting model.

In some aspects, a method for image processing is provided. The method includes: generating, based on image sensor pose information and depth information of a plurality of views of a scene, a three dimensional (3D) mesh of the scene; initializing a Gaussian splatting model based on the 3D mesh of the scene, wherein the Gaussian splatting model includes a plurality of Gaussian splats, and wherein each respective Gaussian splat of the plurality of Gaussian splats includes a respective plurality of parameters corresponding to each view of the plurality of views of the scene; rendering, based on the initialized Gaussian splatting model, a plurality of rendered images of the scene corresponding to one or more views of the plurality of views of the scene; and updating, based on a difference between the plurality of rendered images of the scene and a plurality of images of the scene, one or more parameters of the plurality of parameters of the Gaussian splatting model.

In some aspects, a non-transitory computer-readable medium having stored thereon instructions that, when executed by at least one processor, cause the at least one processor to: generate, based on image sensor pose information and depth information of a plurality of views of a scene, a three dimensional (3D) mesh of the scene; initialize a Gaussian splatting model based on the 3D mesh of the scene, wherein the Gaussian splatting model includes a plurality of Gaussian splats, and wherein each respective Gaussian splat of the plurality of Gaussian splats includes a respective plurality of parameters corresponding to each view of the plurality of views of the scene; render, based on the initialized Gaussian splatting model, a plurality of rendered images of the scene corresponding to one or more views of the plurality of views of the scene; and update, based on a difference between the plurality of rendered images of the scene and a plurality of images of the scene, one or more parameters of the plurality of parameters of the Gaussian splatting model.

In some aspects, an apparatus for image processing is provided. The apparatus includes: means for generating, based on image sensor pose information and depth information of a plurality of views of a scene, a three dimensional (3D) mesh of the scene; means for initializing a Gaussian splatting model based on the 3D mesh of the scene, wherein the Gaussian splatting model includes a plurality of Gaussian splats, and wherein each respective Gaussian splat of the plurality of Gaussian splats includes a respective plurality of parameters corresponding to each view of the plurality of views of the scene; means for rendering, based on the initialized Gaussian splatting model, a plurality of rendered images of the scene corresponding to one or more views of the plurality of views of the scene; and means for updating, based on a difference between the plurality of rendered images of the scene and a plurality of images of the scene, one or more parameters of the plurality of parameters of the Gaussian splatting model.

In some aspects, each of the apparatuses described above is, can be part of, or can include an extended reality (XR) device (e.g., a virtual reality (VR) device, an augmented reality (AR) device, or a mixed reality (MR) device), a vehicle or system or component of the vehicle, a mobile device (e.g., a mobile telephone or so-called “smart phone” or other mobile device), a smart or connected device, a camera system, a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image capture and processing system, in accordance with some aspects of the disclosure.

FIG. 2 is a block diagram illustrating an example of interactions between components of an image capture and processing system, in accordance with some aspects of the disclosure.

FIG. 3 is a block diagram illustrating an example device that may employ a color metadata buffer for 3D reconstruction, in accordance with some aspects of the disclosure.

FIG. 4 is a diagram illustrating an example of a 3D surface reconstruction of a scene modeled as a volume grid, in accordance with some aspects of the disclosure.

FIG. 5 is a diagram illustrating an example of a hash mapping function for indexing blocks (e.g., voxel blocks) in a volume grid, in accordance with some aspects of the disclosure.

FIG. 6 is a diagram illustrating an example of a block (e.g., a voxel block), in accordance with some aspects of the disclosure.

FIG. 7 is a diagram illustrating an example of a truncated signed distance function (TSDF) volume reconstruction, in accordance with some aspects of the disclosure.

FIG. 8 is a diagram illustrating an example of a process for three dimensional Gaussian splatting (3DGS), where the process utilizes structure from motion (SfM) using the COLMAP algorithm to generate a 3D point cloud for 3DGS initialization, in accordance with some aspects of the disclosure.

FIG. 9 is a diagram illustrating an example of a process for 3DGS, where the process utilizes a 3D reconstruction to generate a 3D mesh for 3DGS initialization, in accordance with some aspects of the disclosure.

FIG. 10 is a diagram illustrating an example of a 3D mesh, in accordance with some aspects of the disclosure.

FIG. 11 is a diagram illustrating examples of images with different views generated by a process for 3DGS utilizing SfM using the COLMAP algorithm after thirty-thousand iterations of training, in accordance with some aspects of the disclosure.

FIG. 12 is a diagram illustrating examples of images with different views generated by a process for 3DGS initiated from 3D reconstruction after thirty-thousand iterations of training, in accordance with some aspects of the disclosure.

FIG. 13 is a diagram illustrating examples of images with different views generated by a process for 3DGS with 3D reconstruction assistance after seven-thousand iterations of training, in accordance with some aspects of the disclosure.

FIG. 14 is a flow diagram illustrating an example of a process for 3D reconstruction assisted 3D Gaussian splatting, in accordance with some aspects of the disclosure.

FIG. 15 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, in recent decades, there has been a demand for three-dimensional (3D) content for computer graphics, virtual reality, and communications, triggering a change in emphasis for the requirements. Many existing systems for constructing 3D models are built around specialized hardware resulting in a high cost, and often cannot satisfy the requirements of these new applications. The requirements have stimulated the use of digital imaging (e.g., using images from cameras) for 3D reconstruction.

In some cases, volume blocks (e.g., voxel blocks) can be utilized to reconstruct a 3D scene from two-dimensional (2D) images, such as stereo images obtained from a stereo camera. A voxel block represents a value on a regular grid in 3D space. As with pixels in a 2D bitmap, voxel blocks do not have their position (e.g., coordinates) explicitly encoded within their values. Instead, rendering systems infer the position of a voxel block based upon its position relative to other voxel blocks (e.g., its position in the data structure that makes up a single volumetric image).

In some examples, a system can perform 3D reconstruction (3DR) using depth frames and an associated live camera pose estimate for 3D scene reconstruction. In some cases, when performing 3D surface reconstruction, the system can model the scene as a 3D sparse volumetric representation (e.g., referred to as a volume grid). The volume grid can contain a set of voxel blocks, which are each indexed by their position in space with a sparse data representation (e.g., only storing blocks that surround an object and/or obstacle). In some cases, the scene can be divided into a dense volumetric representation (as opposed to a sparse volumetric representation).

In one illustrative example, a system can perform 3DR to reconstruct a 3D scene from 2D depth frames and color frames. The system can divide the scene into 3D blocks (e.g., voxel blocks or volume blocks, as noted previously). For example, the system may project each voxel block onto a 2D depth frame and a 2D image to determine the depth and/or color of the voxel block. Once all of the voxel blocks that refer to (e.g., are associated with) this depth frame and color frame are updated accordingly, the process can repeat for a new depth frame and color frame pair or set. In some cases, color integration may not be needed. For instance, some 3DR systems may operate on depth and not color. The systems and techniques described herein can apply to depth only 3DR systems and to 3DR systems that operate on depth and color.

As previously mentioned, in 3DR, 3D scenes are represented using a 3D volume of points called voxel blocks, where each voxel block typically carries implicit surface information, such as in the form of a truncated Signed Distance Function (TSDF) value and a weight for depth integration. The TSDF value is a measure of distance of the voxel block from a surface, and the weight is a measure of the reliability of the TSDF value. A TSDF weight can be estimated using various approaches, such as a simple counter (e.g., a binary weight of 1 or 0), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to 1.

A 3DR system may use a sequence of depth maps of a scene with their corresponding six (6) degrees of freedom (DoF) poses as an input. The depth maps can be generated using deep learning (DL) algorithms, non-DL algorithms, and/or other depth estimation methods. A 3D space of the scene can be uniformly sampled along the X, Y, and Z directions. The 3D space can be divided into fixed size volumes (e.g., block volumes with a fixed number of samples).

A 3DR system may include three stages, including block selection, depth integration, and surface extraction. During block selection, blocks that have surfaces or are located close to a surface can be selected. These blocks can then be allocated into memory. In depth integration (also referred to as block integration), all voxel blocks within a block volume can be iterated over and an updated TSDF value weight can be calculated. In surface extraction, marching cubes can be used to determine triangular surfaces in the blocks.

Currently, in order to generate novel views of a 3D environment, two major approaches are generally employed. These two approaches are Neural Radiance Field (NeRF), which is an implicit representation, and 3D Gaussian Splatting (3DGS), which is an explicit representation. NeRF is an artificial intelligence (AI) model that takes 2D images representing a scene as an input, and interpolates between the images to render a complete 3D scene.

3DGS is a technique that creates a 3D scene by projecting points (or splats) from a point cloud (estimated from 2D images of the scene) onto a 3D space, using Gaussian functions for each splat. 2DGS allows for real-time rendering of photorealistic scenes learned from small samples of images. Each Gaussian splat can be described by a number of parameters, which can include position (e.g., an X, Y, Z coordinate of the location), covariance (e.g., how much the Gaussian splat is stretched/scaled along the three orthogonal directions, i.e., the eigenvectors of the covariance), color (e.g., red, green, blue and its variability depending on the viewing angel using the Spherical Harmonic coefficients), and level of transparency.

The process for 3DGS starts by using a structure from motion (SfM) method to estimate a 3D point cloud from a set of 2D images of the scene. The SfM method may be performed by using the COLMAP algorithm. Each point in the point cloud is then converted into a Gaussian splat. This conversion into Gaussian splats is sufficient to provide rasterization for the scene. However, only position and color can be inferred from the SfM data. Training needs to be performed to learn a representation that yields high quality results.

The training procedure for 3DGS uses a stochastic gradient descent (e.g., which is similar to a neural network, but without the layers). During the training, the Gaussian splats are rasterized to an image (e.g., corresponding to a view of the scene) using differentiable Gaussian rasterization (e.g., using a differentiable rendering algorithm). A loss is determined based on a difference between the rasterized image of the scene and a ground truth image of the scene. The parameters of the Gaussian splats are adjusted according to the loss. Automated densification and pruning of the Gaussian splats are applied. The training allows for the 3D scene to be generated with photorealistic details.

Since 3DGS can be rendered quickly due to a differentiable rendering algorithm and can generate arbitrary 2D projections, 3DGS has gained a significant amount of attention, which has pushed NeRF to the sidelines. 3DGS relies on a 3D point cloud generated from SfM using the COLMAP algorithm followed by training to control the density of the Gaussian splats and to tune the parameters (e.g., including location, orientation, extent (scale), opacity, and view-dependent color in terms of spherical harmonics). After the training session has completed, an explicit representation of the scene is obtained that can be rendered for arbitrary viewpoints of the scene.

The quality of this explicit representation relies heavily on the initial point cloud and the 2D ground truth images captured from the scene to tune the Gaussian splats. In cases where the point cloud is reliable (e.g., and, as such, the 3DGS initialization is reliable) and there is sufficient variability in the collected 2D images of the scene, given a sufficient number of training iterations, 3DGS should produce a reasonable 3D model of the scene.

However, as the amount of variance in the views of the collected 2D images of the scene reduces (e.g., when a user looks to a part of the scene with not much change in the image sensor position), it should be expected that not only the quality of the point cloud generated with the COLMAP algorithm to degrade (e.g., which can lead to a poor initialization of the Gaussian splats), but also that a limited variation in views of the captured images used cannot successfully direct the Gaussian splats to produce a realistic 3D representation of the scene. Although the 2D rendered images obtained from the same location (e.g., same image sensor view) as the training samples may look reasonable, images rendered from other locations (e.g., from novel views) would show that the 3D representation has not been successful (e.g., is not realistic). As such, due to a lack of variance of views of the collected 2D images, the Gaussian splats may not be able to produce a realistic 3D representation.

As such, improved systems and techniques for 3DGS that produce a realistic 3D representation for a scene (even when using, for initializing the Gaussian splats, 2D images of the scene with a lack of variance of views of the scene) can be beneficial.

In some aspects of the present disclosure, systems, apparatuses, methods (also referred to as processes), and computer-readable media (collectively referred to herein as “systems and techniques”) are described herein for 3D reconstruction assisted 3D Gaussian splatting.

Various aspects relate generally to image processing. Some aspects more specifically relate to systems and techniques that provide solutions that leverage 3D reconstruction to produce geometric priors for 3DGS initialization and guidance that can lead to high-quality results and substantially reduced training times, as compared to original 3DGS. In one or more examples, for the systems and techniques, a 3DR system can be employed that (given camera pose information and depth sensor information) can provide a 3D mesh that represents surfaces within a scene. The 3D mesh is constructed from vertices forming triangles. From each triangle of the 3D mesh, a surface normal can be calculated. The 3D mesh provides opportunities to initialize the 3D Gaussian splats, improve the training time, and reduce the computational loads. As 3DR identifies surfaces and due to initiating Gaussian splats on the surfaces, an opacity value (e.g., a Gaussian splat parameter) may be dropped, which can further reduce the burden of training. With these geometric priors, the training required for 3DGS can be simplified.

Particular aspects of the subject matter described in this disclosure can be implemented to realize one or more of the following potential advantages. In one or more examples, the systems and techniques have the benefit of providing a system for 3DGS that provides a high-quality, realistic 3D representation of a scene with reduced training times for the 3DGS.

In one or more examples, during operation of the systems and techniques for 3D reconstruction assisted 3D Gaussian splatting, one or more processors can generate, (using 3D reconstruction) based on image sensor pose information and depth information of a plurality of views of a scene, a 3D mesh of the scene. In one or more examples, the 3D mesh can include a plurality of vertices forming a plurality of triangles that represent a plurality of surfaces within the scene. The one or more processors can initialize a Gaussian splatting model based on the 3D mesh of the scene. In one or more examples, the Gaussian splatting model can include a plurality of Gaussian splats positioned relative to the plurality of triangles. In one or more examples, each respective Gaussian splat of the plurality of Gaussian splats can include a respective plurality of parameters corresponding to each view of the plurality of views of the scene. The one or more processors can render, based on the initialized Gaussian splatting model, a plurality of rendered images of the scene corresponding to one or more views of the plurality of views of the scene. The one or more processors can update, based on a difference between the plurality of rendered images of the scene and a plurality of images of the scene, one or more parameters of the plurality of parameters of the Gaussian splatting model.

In one or more examples, initializing the Gaussian splatting model based on the 3D mesh of the scene can include placing a respective Gaussian splat of the plurality of Gaussian splats onto each triangle of the plurality of triangles. In some examples, updating the one or more parameters can include determining a feedback error based on a difference between the plurality of rendered images of the scene and the plurality of images of the scene. In one or more examples, updating the one or more parameters further can include training, based on the feedback error, the Gaussian splatting model to tune the one or more parameters of the Gaussian splatting model.

In some examples, the respective plurality of parameters for each Gaussian splat can include a color, a location comprising three coordinates, an orientation, a respective scale for each direction of three directions, and/or an opacity. In one or more examples, the one or more processors can generate, based on sub-sampling the plurality of triangles of the 3D mesh, a simplified 3D mesh of the scene. In some examples, the one or more processors can generate, based on merging at least some triangles of the plurality of triangles together to generate a reduced set of triangles, a simplified 3D mesh of the scene.

In one or more examples, each Gaussian splat of the plurality of Gaussian splats can include three scale parameters. In some examples, a first scale parameter of the three scale parameters can be in a direction of a semi-major axis of the Gaussian splat, a second scale parameter of the three scale parameters can be in a direction of a semi-minor axis of the Gaussian splat, and a third scale parameter of the three scale parameters can be in a direction of a normal vector of a triangle of the plurality of triangles corresponding to the 3D mesh. In one or more examples, the third scale parameter can be set to zero.

In some examples, one or more image sensors can obtain the plurality of images of the scene from the plurality of views of the scene. In one or more examples, the opacity parameter for each Gaussian splat of the plurality of Gaussian splats can be set to a fixed value (e.g., zero or one). In some examples, the 3D mesh can provide material information for each triangle of the plurality of triangles, and the material information can be associated with texture information. In one or more examples, when the material information indicates an opaque material or a transparent material for a triangle of the plurality of triangles, the opacity parameter for a Gaussian splat corresponding to the triangle can be set to a fixed value.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

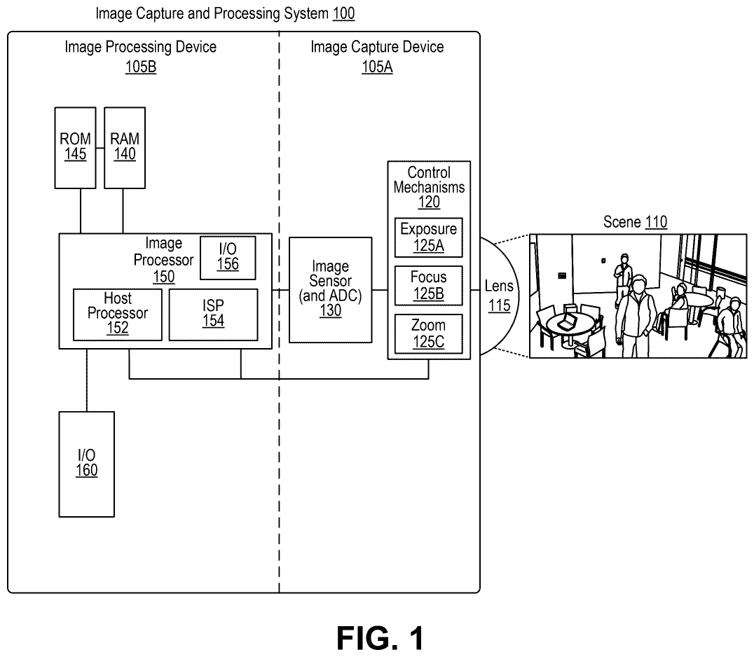

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1510 discussed with respect to the computing system 1500. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1525, read-only memory (ROM) 145/1518, a cache 1512, system memory 1515, another storage device 1530, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1535, any other input devices 1545, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Host processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations. In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

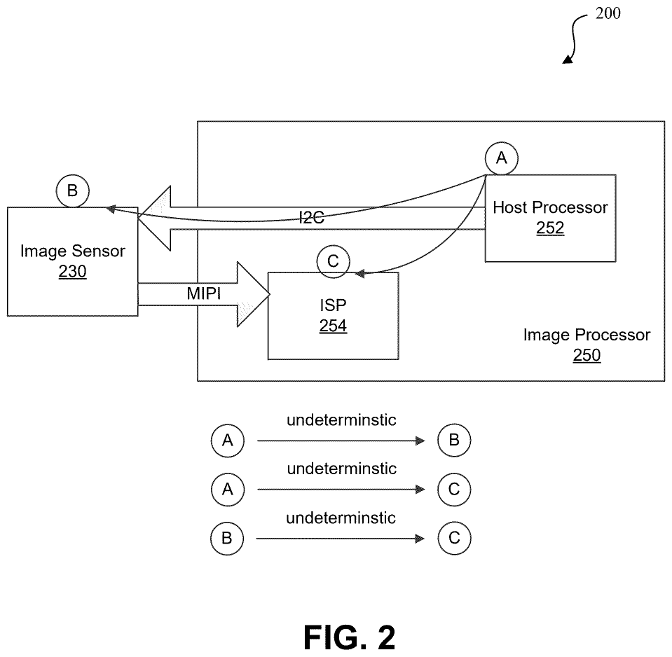

Synchronization between the image sensor 130 and the ISP 154 is important in order to provide an operational image capture system that generates high quality images without interruption and/or failure. FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and programs the ISP 254 parameter settings with a second fixed period of time, such as 1-frame period ahead of when that image frame will be processed by the ISP 254.

The image sensor 230 can send image frames to the ISP 254 (B-to-C in FIG. 2), such as over an MIPI CSI-2 PHY port or interface, or other suitable interface. However, the communication between the host processor 252 and the image sensor 230 (shown as from A to B) is undeterministic. Similarly, the communication between the image sensor 230 and the ISP 254 (shown as from B to C) and the communication the host processor 252 and the ISP 254 (shown as from A to C) are also undeterministic. For example, there can be varying latencies in programming of the image sensor 230 and the ISP 254 by the host processor 252, which can result in a parameter settings mismatch between the sensor and the ISP. The latencies can be due to high CPU usage, congestion in one or more I/O ports, and/or due to other factors.

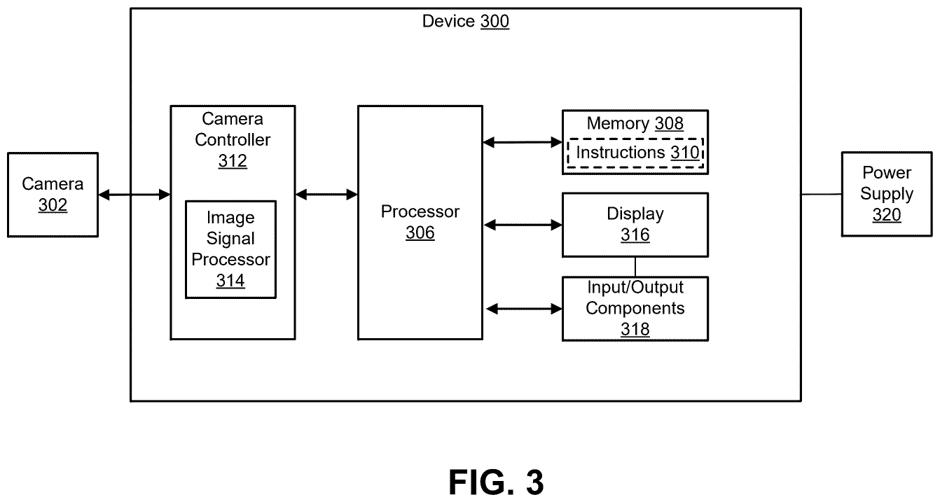

FIG. 3 is a block diagram of an example device 300 that may employ a color metadata buffer for 3D reconstruction. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and

I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF process, an AWB process, and/or an AE process. In some examples, ISP 314 and/or camera controller 312 may include hardware-specific circuits (e.g., an application-specific integrated circuit (ASIC)) configured to perform the AF, AWB, and/or AE processes. In other examples, ISP 314 and/or camera controller 312 may be configured to execute software and/or firmware to perform the AF, AWB, and/or AE processes. When configured in software, code for the AF, AWB, and/or AE processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE processes using a combination of hardware, firmware, and/or software. When configured as software, AF, AWB, and/or AE processes may include instructions that configure ISP 314 and/or camera controller 312 to perform various image processing and device managements tasks, including the techniques of this disclosure.

As previously mentioned, recently, there has been a demand for 3D content for computer graphics, virtual reality, and communications, that has triggered a change in emphasis for the requirements. Many existing systems for constructing 3D models are built around specialized hardware that results in a high cost, which often cannot satisfy the requirements of these new applications. This need has stimulated the use of digital imaging facilities (e.g., cameras) for 3D reconstruction.

Currently, volume blocks (e.g., voxel blocks) are often used to reconstruct a 3D scene from 2D images (e.g., stereo images obtained from a stereo camera). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

3DR utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four centimeter block dimension. In some examples, for this room, the occupied voxel blocks may only be about ten to fifteen percent.

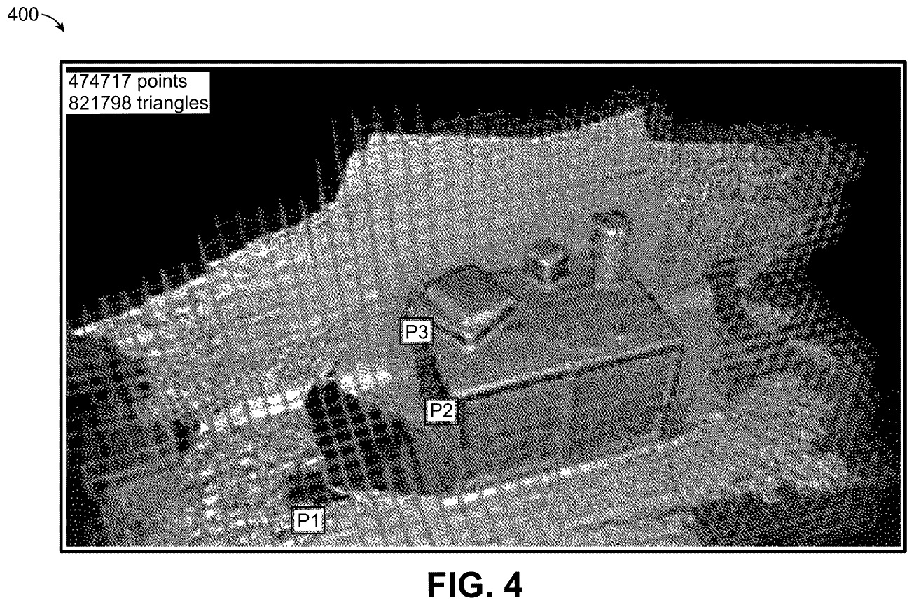

FIG. 4 shows an example of a scene that has been modeled as a 3D sparse volumetric representation for 3DR. In particular, FIG. 4 is a diagram illustrating an example of a 3D surface reconstruction 400 of a scene modeled with an overlay of a volume grid containing voxel blocks. For 3DR, a camera (e.g., a stereo camera) may take photos of the scene from various different view points and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel block) located at point P2 within the scene may be taken by a camera (e.g., a stereo camera) located at point P1 with a certain camera pose (e.g., at a certain angle). The camera can capture depth and in some cases can also capture color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel block). An integrate process can occur where all of the blocks within the scene are passed through an integrate function. The integrate function can determine depth information for each of the blocks from the depth frame and can update each block to indicate whether the block has a surface or not. In cases where the 3DR algorithm or system integrates color, the blocks that are determined to have a surface can then be updated with a color. In other cases, for 3DR systems that operate on depth (without color), color may not be added to or integrated with the blocks.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxel blocks), instead of using a large memory lookup table, various different volume block representations may be used to index the blocks in the 3D scene to store data where the measurements are observed. Volume block representations that may be employed can include, but are not limited to, a hash map lookup, an octree, and a large blocks implementation.

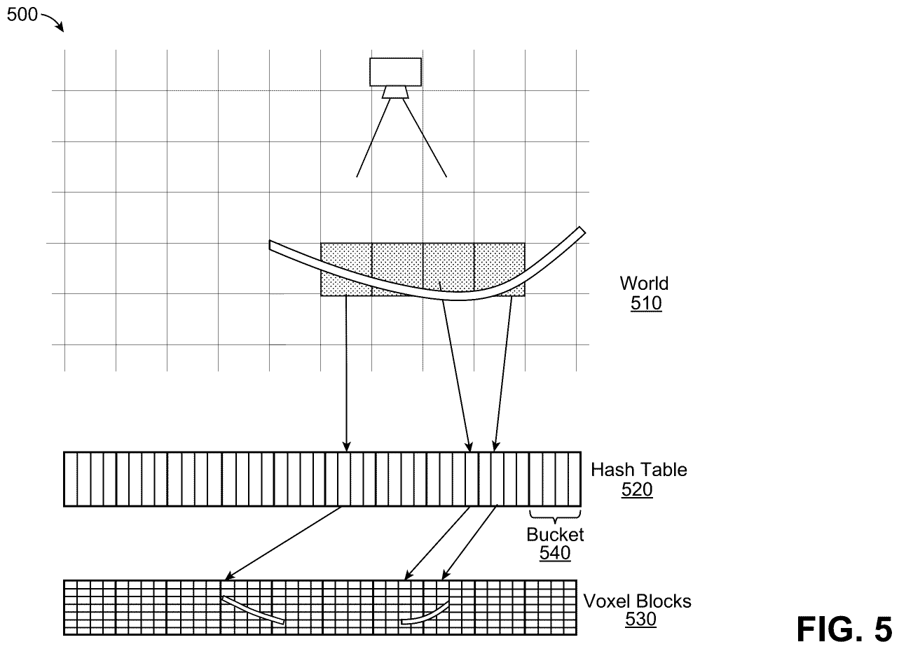

FIG. 5 shows an example of a hash map lookup type of volume block representation. In particular, FIG. 5 is a diagram illustrating an example of a hash mapping function 500 for indexing voxel blocks 530 in a volume grid. In FIG. 5, a volume grid is shown with world coordinates 510. Also shown in FIG. 5 are a hash table 520 and voxel blocks 530. In one or more examples, a hash function can be used to map the integer world coordinates 510 into hash buckets 540 within the hash table 520. The hash buckets 540 can each store a small array of points to regular grid voxel blocks 530. Each voxel block 530 contains data that can be used for depth integration.

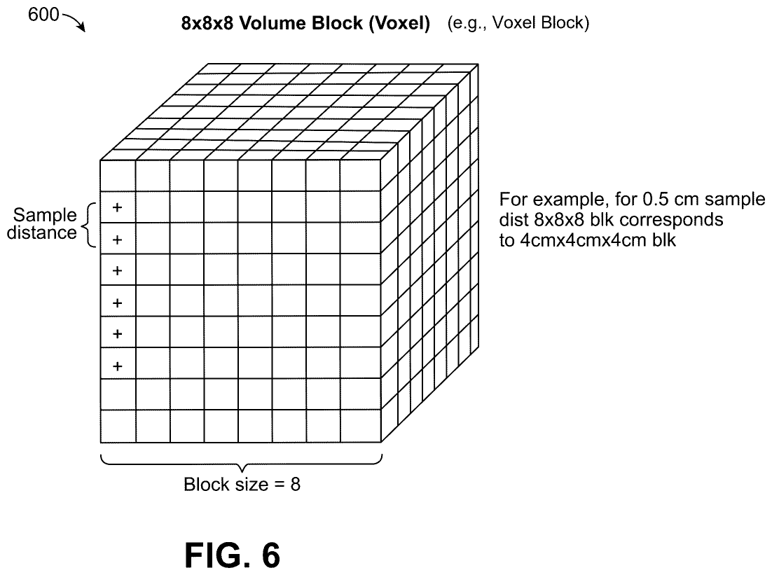

FIG. 6 is a diagram illustrating an example of a volume block (e.g., a voxel block) 600. In FIG. 6, the voxel block 600 is shown to have a block size of eight. For example, a 0.5 centimeter (cm) sample distance for an eight by eight by eight voxel block can correspond to a four cm by four cm by four cm voxel block. That is, the voxel block 600 includes a 3D lattice of 512 voxels, the voxels arranged so that the voxel block 600 has a width of 8 voxels, a length of 8 voxels, and a height of 8 voxels.

In one or more examples, each voxel block (e.g., voxel block 600) can contain or store truncated signed distance function (TSDF) samples and a weight. In some cases, each voxel can also contain or store color values (e.g., red-green-blue (RGB) values). TSDF is a function that measures the distance d of each pixel from the surface of an object to the camera. A voxel block with a positive value for d can indicate that the voxel block is located in front of a surface, a voxel block with a negative value for d can indicate that the voxel block is located inside (or behind) the surface, and a voxel block with a zero value for d can indicate that the voxel block is located on the surface. The distance d is truncated to [−1, 1], for example based on Equation (1) below:

$$tsdf = \{ \begin{matrix}- 1 , & if d \leq - ramp \\ \frac{d}{ramp} , & if - ramp < d < ramp \\ 1 , & if d \geq ramp\end{matrix} \} \qquad Equation ( 1 )$$

$$sample . tsdf = ( \frac{sample . weight * sample . tsdf + tsdf}{sample . weight + 1} )$$

A TSDF integration or fusion process can be employed that updates the TSDF values and weights with each new observation from the sensor (e.g., camera).

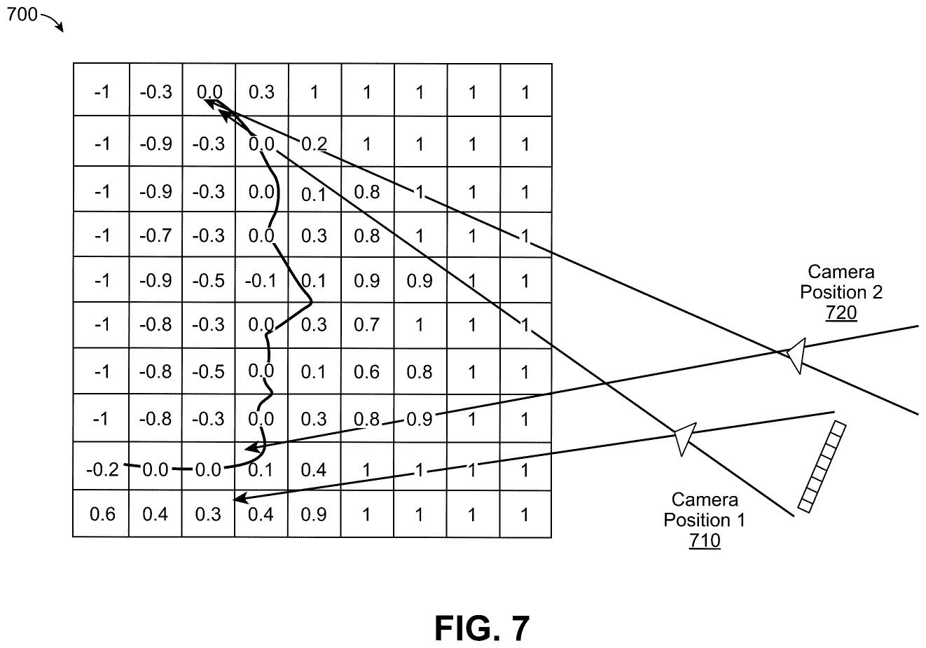

FIG. 7 is a diagram illustrating an example of a TSDF volume reconstruction 700. In FIG. 7, a voxel grid including a plurality of voxel blocks is shown. A camera is shown to be obtaining images of a scene (e.g., person's face) from two different camera positions (e.g., camera position 1 710 and camera position 2 720). During operation for TSDF, for each new observation (e.g., image) from the camera (e.g., for each image taken by the camera at a different camera position), the distance (d) of a corresponding pixel of each voxel block within the voxel grid can be obtained. The distance (d) value can be truncated by comparing a threshold value (e.g., referred to as a ramp) to derive a current TSDF value, and the current TSDF value can be integrated to the TSDF volume, such as by using a weighted averaging (e.g., as shown in equation 1 above). The TSDF values (and in some cases color values) can be updated in the global memory. In FIG. 7, the voxel blocks with positive values are shown to be located in front of the person's face, the voxel blocks with negative values are shown to be located inside of the person's face, and the voxel blocks with zero values are shown to be located on the surface of the person's face.

As previously mentioned, currently, to generate novel views of a 3D environment, two major approaches are employed, which are Neural Radiance Field (NeRF) (e.g., which is an implicit representation) and 3D Gaussian Splatting (3DGS) (e.g., which is an explicit representation). Since 3DGS can be rendered quickly due to a differentiable rendering algorithm and can generate arbitrary 2D projections, 3DGS has gained a significant amount of attention, which caused NeRF to be less popular to use. 3DGS relies on a 3D point cloud generated from SfM using the COLMAP algorithm followed by training to control the density of the Gaussian splats and to tune the parameters of the Gaussian splats. After the training session is complete, an explicit representation of the scene is obtained that can be rendered for arbitrary views of the scene.

Quality of 3DGS rendering relies on the initial point cloud and the 2D ground truth images captured from the scene to tune the Gaussian splats. Due to variance in the views of the collected images, the Gaussian splats may not produce a realistic 3D representation of the scene. Thus, although 2D rendered images from the same view location as training samples may look reasonable, images rendered from other locations would show that the 3D representation may not be realistic.

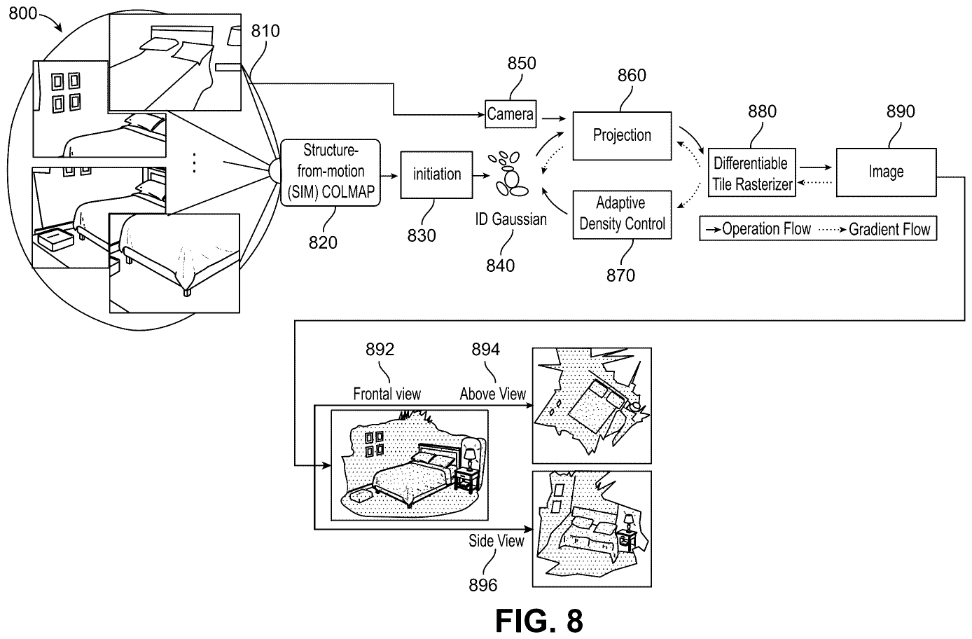

FIG. 8 shows examples of images rendered of a scene by a process for 3DGS (using a 3DGS model) that generates a 3D point cloud from SfM using the COLMAP algorithm. In particular, FIG. 8 is a diagram illustrating an example of a process 800 for 3DGS, where the process 800 utilizes SfM using the COLMAP algorithm to generate a 3D point cloud for 3DGS initialization.

During operation of the process 800 for 3DGS of FIG. 8, one or more image sensors can obtain a plurality of 2D images 810, from a plurality of different views (e.g., different image sensor poses), of a scene. The 2D images 810 are used to train the 3DGS model. Once training of the 3DGS model is completed, the trained 3DGS model can be used to render generated images from other views (the same or different views as those in the 2D images 810). For example, the generated images may include a frontal view image 892, an above view image 894, and a side view image 896.

SfM 820 (e.g., which can use the COLMAP algorithm) can estimate a 3D point cloud from the plurality of 2D images 810 of the scene. The 3D point cloud can be used for initialization 830 of the Gaussian splats. For example, each point in the 3D point cloud can be converted into a Gaussian splat to produce a plurality of 3D Gaussian splats 840. The conversion of the points into Gaussian splats should be sufficient to provide rasterization for the scene. However, only the position and color parameters for the Gaussian splats may be inferred from the SfM data. Training should be performed (e.g., on parameters, projections 860, and adaptive density control 870 of the Gaussian splats according to the different views (e.g., poses) of the image sensor 850 (e.g., camera) when capturing the 2D images 810 to learn a representation that yields high quality results.

The training procedure for 3DGS can employ a stochastic gradient descent technique (e.g., which is similar to a neural network, but without the layers) based on the 2D images 810. During the training, the Gaussian splats can be rasterized to one or more images 890 (e.g., each corresponding to a different view of the scene depicted in the input 2D images 810) using a differentiable tile rasterizer 880 (e.g., using a differentiable rendering algorithm). A loss can then be determined based on a difference between the rasterized images 890 of the scene and ground truth images (e.g., the 2D images 810) of the scene. The parameters of the Gaussian splats may be adjusted according to the loss. Automated densification (e.g., adaptive density control 870) and pruning of the Gaussian splats can also applied.

When the 2D images 810 have a sufficient variance in different views, the training can allow for the 3D scene to be generated from various different viewpoints with realistic details (e.g., generated images, such as the frontal view image 892, the above view image 894, and the side view image 89). As shown in FIG. 8, since the frontal view image 892 provides realistic results for the scene, but the above view image 894 and the side view image 896 do not provide realistic results for the scene, it is evident that the 2D images 810 did not contain a sufficient amount of views (e.g., the above view and the side view) of the scene.

The 3DGS process 800 heavily relies on SfM using the COLMAP algorithm, which depends on visual features and variability in the 2D images 810 to produce a high quality 3D point cloud used by 3DGS. Dealing with texture-less surfaces, such as walls, or flat surfaces (e.g., such as flat surfaces on furniture), can be detrimental to the overall results. For example, the flat surfaces (e.g., walls and top of bed) in the above view image 894 and the side view image 896 are not shown to be realistic for the scene.

Therefore, improved systems and techniques for 3DGS that produce a realistic 3D representation a scene (even when using, for initializing the Gaussian splats, 2D images of the scene with a lack of variance of views of the scene) can be useful.

In one or more aspects, the systems and techniques provide 3D reconstruction assisted 3D Gaussian splatting. In one or more examples, the systems and techniques provide solutions that leverage 3D reconstruction to produce geometric priors for 3DGS initialization and guidance that can lead to high-quality results and substantially reduced training times, as compared to original 3DGS. In some examples, a 3DR system may be employed that (given camera pose information and depth sensor information) can provide a 3D mesh that represents surfaces within a scene. The 3D mesh is constructed from vertices forming triangles, where a surface normal can be calculated from each triangle. The 3D mesh can provide opportunities to initialize the 3D Gaussian splats, improve the training time, and reduce the computational loads. As 3DR identifies surfaces and due to initiating Gaussian splats on the surfaces, an opacity value (e.g., a Gaussian splat parameter) can be dropped that can further reduce the computational burden of training. By using these geometric priors, the training needed for 3DGS can be simplified and reduced.

As mentioned, the original 3DGS process (e.g., process 800 of FIG. 8) relies on SfM (e.g., using the COLMAP algorithm), which depends on visual features and variability in the 2D images 810 to produce a high quality 3D point cloud for initiating the Gaussian splats. As such, the rendered images (e.g., above view image 894 and side view image 896) may not realistically show texture-less surfaces, such as walls, or flat surfaces, in the scene specifically from novel view-points. However, 3DR is immune to such issues because 3DR operates based on depth input, and can produce a 3D mesh that geometrically represent surfaces (e.g., including texture-less surfaces) successfully.

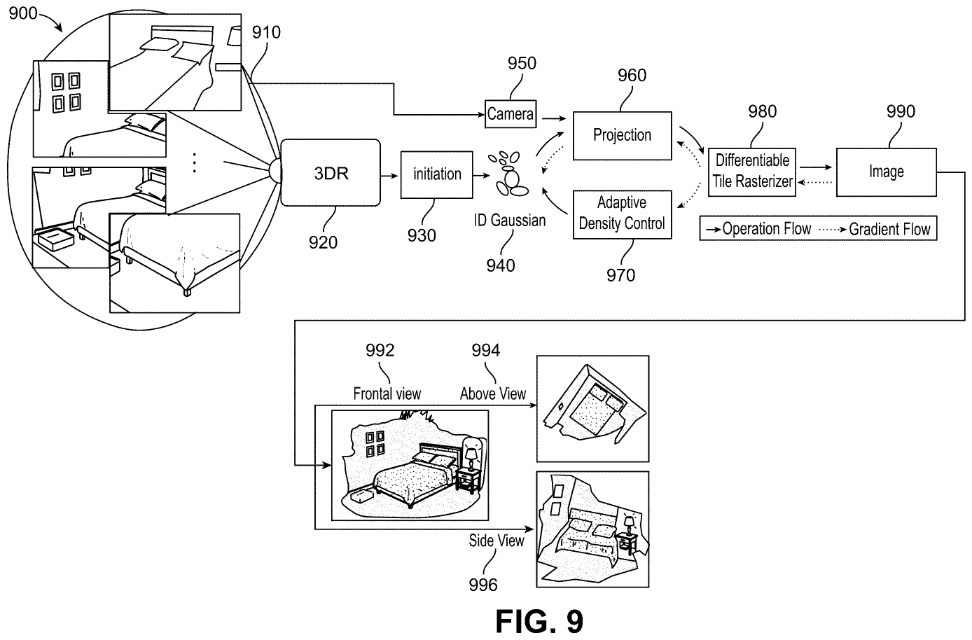

FIG. 9 shows examples of images rendered of a scene by a process for 3DGS that generates a 3D mesh from 3DR. In particular, FIG. 9 is a diagram illustrating an example of a process 900 for 3DGS, where the process 900 utilizes a 3DR to generate a 3D mesh for 3DGS initialization.

During operation of the process 900 for 3DGS of FIG. 9, one or more image sensors can obtain a plurality of 2D images 910, from a plurality of different views (e.g., different image sensor poses), of a scene. 3DR 920 (e.g., one or more processors performing 3DR) can generate, based on image sensor pose information and depth information of the different views of the scene, a 3D mesh of the scene. The 3D mesh can include a plurality of vertices forming triangles that represent the surfaces within the scene.

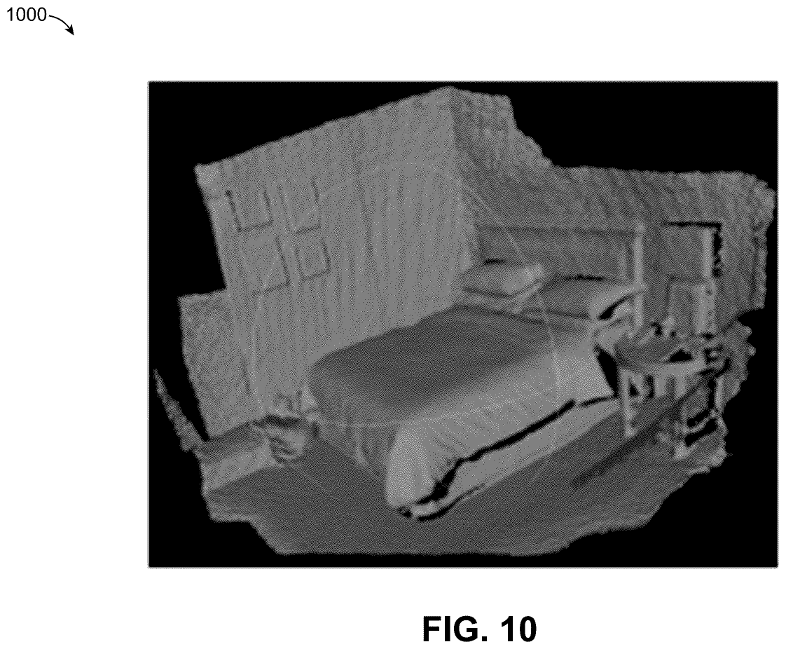

FIG. 10 shows an example of a 3D mesh of the scene. In particular, FIG. 10 is a diagram illustrating an example of a 3D mesh 1000. In one or more examples, the 3D mesh 1000 can be a triangular mesh. For each triangle, the average vertex location can be calculated to be used for the location component (e.g., position parameter, which may be an X, Y, Z coordinate) for a Gaussian splat.

Depending upon the resolution (e.g., density) of the triangles of the 3D mesh 1000, the 3D mesh 1000 may be simplified, sub-sampled, or resampled to produce a simplified 3D mesh (or a dense 3D mesh) of the scene to be used for the initialization 930 of the Gaussian splats. In one or more examples, when the 3D mesh 1000 is dense, one or more processors can generate, based on merging at least some triangles of the 3D mesh 1000 together to generate a reduced set of triangles, a simplified 3D mesh of the scene. In some examples, the one or more processors may utilize a mesh simplification algorithm to merge some of the triangles of the 3D mesh 1000 together to produce the simplified 3D mesh. In one or more examples, when the 3D mesh 1000 is dense, one or more processors can generate, based on sub-sampling triangles of the 3D mesh 1000, a simplified 3D mesh that includes a reduced set of triangles. In some examples, when the 3D mesh 1000 is sparse, one or more processors can generate, by resampling the 3D mesh 1000, a more dense 3D mesh including an expended set of triangles.

The 3D mesh 1000 (or 3D simplified mesh or 3D dense mesh) can be used for initialization 930 of the Gaussian splats. In one or more examples, one or more processors can initialize a Gaussian splatting model based on the 3D mesh 1000 of the scene, where the Gaussian splatting model includes a plurality of Gaussian splats 940 positioned relative to the triangles of the 3D mesh 1000. In one or more examples, initializing the Gaussian splatting model includes placing a respective Gaussian splat onto each triangle of the 3D mesh 1000. In one or more examples, for each chosen triangle in the 3D mesh 1000, a respective surface normal can be used to compute and guide the orientation and scale of a corresponding Gaussian splat to produce the plurality of 3D Gaussian splats 940.

In one or more examples, each Gaussian splat can include a plurality of parameters corresponding to each of the views of the scene. In some examples, the parameters can include, but are not limited to, color, a location in three coordinates (e.g., X, Y, Z coordinates), an orientation, a respective scale for each direction of three directions (e.g., including a direction of the semi-major axis, a direction of the semi-minor axis, and a direction of the normal vector of a triangle corresponding to the Gaussian splat), and/or opacity (e.g., which may range between zero and one, where zero can indicate a transparent surface and one can indicate an opaque surface). The opacity parameter can determine or indicate the strength or intensity of the Gaussian.

As triangles are 2D entities, each 3D Gaussian splat (e.g., which may be in the form of a 3D ellipsoid) can be forced to also be 2D (e.g., which may be in the form of a 2D ellipse). As such, instead of assigning three scale factors to each Gaussian splat (e.g., corresponding to directions of the semi-major axis, semi-minor axis, and the normal vector to the triangle corresponding to the Gaussian splat), values are only assigned to scales in two directions (e.g., a direction of the semi-major axis and a direction of the semi-minor axis) with the assumption that scale in the third direction (e.g., a direction of the normal vector to the triangle) is set to zero. Therefore, in one or more examples, each Gaussian splat of the plurality of Gaussian splats 940 can include three scale parameters, where a first scale parameter of the three scale parameters is in a direction of a semi-major axis of the Gaussian splat, where a second scale parameter of the three scale parameters is in a direction of a semi-minor axis of the Gaussian splat, and where a third scale parameter of the three scale parameters is in a direction of a normal vector of a triangle of the plurality of triangles of the 3D mesh 1000 corresponding to the Gaussian splat, and the third scale parameter can be set to zero.

In one or more examples, an orientation (q) of each of the Gaussian splats 940 can be encoded via the concept of quaternions (e.g., where a quaternion represents a complex number equivalent to a 3D rotation). In some examples, a rotation between a surface normal ( [symbol] ) to a triangle corresponding to a Gaussian splat and the z-axis ( [symbol] ) of a world coordinate system (or any other known and fixed system vector) can be used to obtain the four-value quaternion for each Gaussian splat. In one or more examples, the four-value quaternion representing the orientation (q) for a Gaussian splat can be calculated by using the following equations:

$$\vec{r} = \vec{n} \times \vec{z}$$

$$\vec{{r}_{n}} = \vec{r} / ‖ \vec{r} ‖$$

$$θ = {cos}^{- 1} ( \frac{\vec{n} \cdot \vec{z}}{‖ \vec{n} ‖ \cdot ‖ \vec{z} ‖} )$$

$${q}_{r} = cos \frac{θ}{2} , {q}_{i} = {r}_{{n}_{x}} sin \frac{θ}{2} , {q}_{j} = {r}_{{n}_{y}} sin \frac{θ}{2} , {q}_{k} = {r}_{{n}_{z}} sin \frac{θ}{2}$$

$$q = ( {q}_{r} , {q}_{i} \cdot {q}_{j} , {q}_{k} )$$

After the initialization 930 of the Gaussian splats, training should be performed (e.g., on parameters, projections 960, and adaptive density control 970 of the Gaussian splats according to the different views (e.g., poses) of the image sensor 950 (e.g., camera) when capturing the 2D images 910 to learn a representation that produces realistic results.

The training procedure for 3DGS can utilize a stochastic gradient descent (e.g., which is similar to a neural network, but without the layers). During the training, the Gaussian splats of the Gaussian splatting model can be rasterized (rendered) to one or more images 990 (e.g., each corresponding to a different view of the scene) utilizing a differentiable tile rasterizer 980 (e.g., using a differentiable rendering algorithm). Once trained, the 3DGS model can generate images from different views of the scene (views not included in the 2D images 910), such as a frontal view image 992, an above view image 994, and a side view image 996.

In one or more examples, the parameters of the Gaussian splats of the Gaussian splatting model can be updated (e.g., adjusted or tuned) based on a difference between the rasterized images 990 of the scene and ground truth images (e.g., the 2D images 910) of the scene. In one or more examples, updating the parameters can include determining a loss (e.g., a feedback error) based on the difference between the rasterized images 990 of the scene and ground truth images (e.g., the 2D images 910) of the scene. In some examples, updating the parameters can further include training, based on the loss (e.g., the feedback error), the Gaussian splatting model to tune the one or more parameters. As such, the parameters of the Gaussian splats may be adjusted (e.g., updated) according to the loss (e.g., the feedback error). Automated densification (e.g., adaptive density control 970) and pruning of the Gaussian splats may also be performed.

In one or more examples, cases where the input depth is reliable and the 3DR is accurate, the location parameter (X, Y, Z) for the Gaussian splats can be fixed and excluded from training. In some examples, since the 3D mesh 1000 establishes surfaces within the scene, the computed quaternions (q) for the orientation parameters of Gaussian splats can be excluded from training.

In some examples, the 3D mesh 1000 (e.g., generated by 3DR) provides material information for the surfaces associated with each triangle of the 3D mesh 1000. In one or more examples, the material information is associated with texture information. The material information can indicate an opaque material or a transparent material and, as such, the opacity parameter can be set to a fixed value. As 3DR identifies surfaces of the scene and due to initiating gaussians on the surfaces, the opacity parameter can be excluded from the training, which can further reduce the burden of training. Whether the opacity parameter should be excluded (or included) in the training can be dependent upon the quality of the 3DR.

3DGS, given a good initialization, variability in collected samples, and a relatively high number of training iterations can produce reasonable results. As shown in FIG. 9, the frontal view image 992, the above view image 994, and the side view image 996 all provide realistic results for the scene. Benefiting from a 3DR mesh can substantially reduce the training time required for 3DGS. In one or more examples, as mentioned, Gaussian splats can be restricted to be 2D rather than 3D entities following the mesh normal directions, and can have fixed locations as vertices. This 2D restriction of the Gaussian splats essentially simplifies the problem to only mesh painting. The assistance of generating a 3D mesh from 3DR can significantly improve 3DGS efficiency and generation time at a much lower required power.

Incorporating valuable geometric priors from 3DR can significantly improve the training time of the original 3DGS (e.g., process 800 of FIG. 8), improve the accuracy of the 3D model even under limited variability of collected samples, and overall reduce the computational costs associated with 3DGS, especially on the edge devices, such as mobile phones.

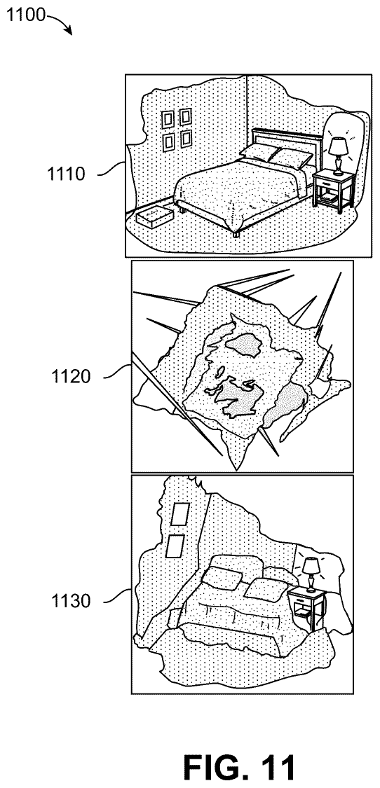

FIGS. 11, 12, and 13 show example images that are rendered using different 3DGS processes. In particular, FIG. 11 is a diagram illustrating examples of images 1100 with different views generated by a process (e.g., process 800 of FIG. 8) for 3DGS utilizing SfM using the COLMAP algorithm after thirty-thousand (30k) iterations of training. FIG. 11 shows a frontal view image 1110, an above view image 1120, and a side view image 1130. For the 3DGS process, the plurality of images used as an input include a limited amount of views (e.g., of the frontal view) of the scene. As shown in FIG. 11, the above view image 1120 and the side view image 1130 do not include realistic results for the scene. FIG. 11 also shows that, due to the use of SfM in the process, the flat surfaces (e.g., walls) of the frontal view image 1110 do not appear realistic.

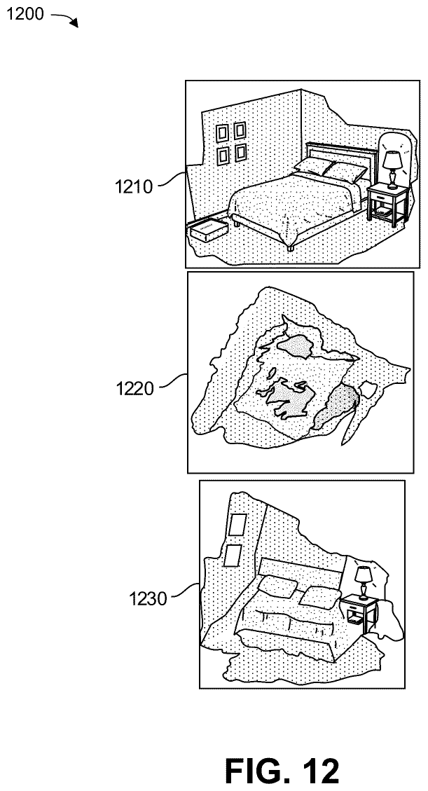

FIG. 12 is a diagram illustrating examples of images 1200 with different views generated by a process (e.g., process 900 of FIG. 9) for 3DGS initiated from 3D reconstruction after thirty-thousand (30k) iterations of training. FIG. 12 shows a frontal view image 1210, an above view image 1220, and a side view image 1230. For the 3DGS process, the 2D images used as an input include a limited amount of views (e.g., of the frontal view) of the scene. For the training of the 3DGS process, only the location parameter of the Gaussian splats is fixed and excluded from the training. Only excluding the location parameter from the training causes the remaining parameters of the Gaussian splats to be over-tuned. As such, as shown in FIG. 12, the above view image 1220 and the side view image 1230 do not include realistic results for the scene.

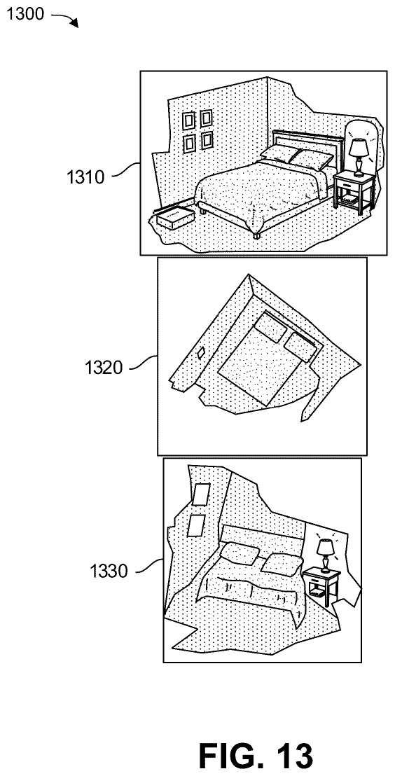

FIG. 13 is a diagram illustrating examples of images 1300 with different views generated by a process (e.g., process 900 of FIG. 9) for 3DGS with 3D reconstruction assistance after seven-thousand (7k) iterations of training. FIG. 13 shows a frontal view image 1310, an above view image 1320, and a side view image 1330. For the 3DGS process, the images used as an input include a limited amount of views (e.g., of the frontal view) of the scene. For the training of the 3DGS process, the location parameter, the orientation parameter, the scale parameter in one direction, and the opacity parameter of the Gaussian splats are fixed and excluded from the training. As shown in FIG. 12, the frontal view image 1310, the above view image 1220, and the side view image 1230 all include realistic results for the scene.

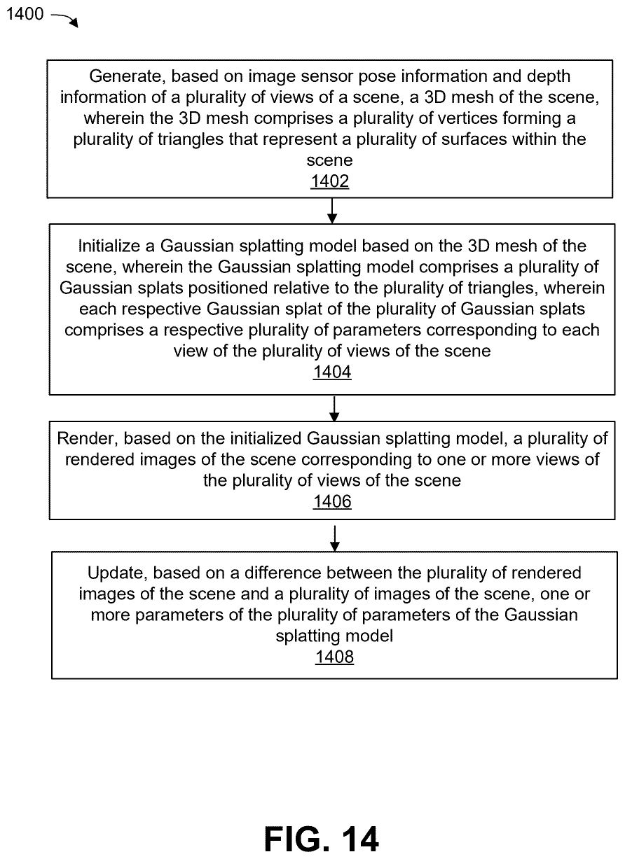

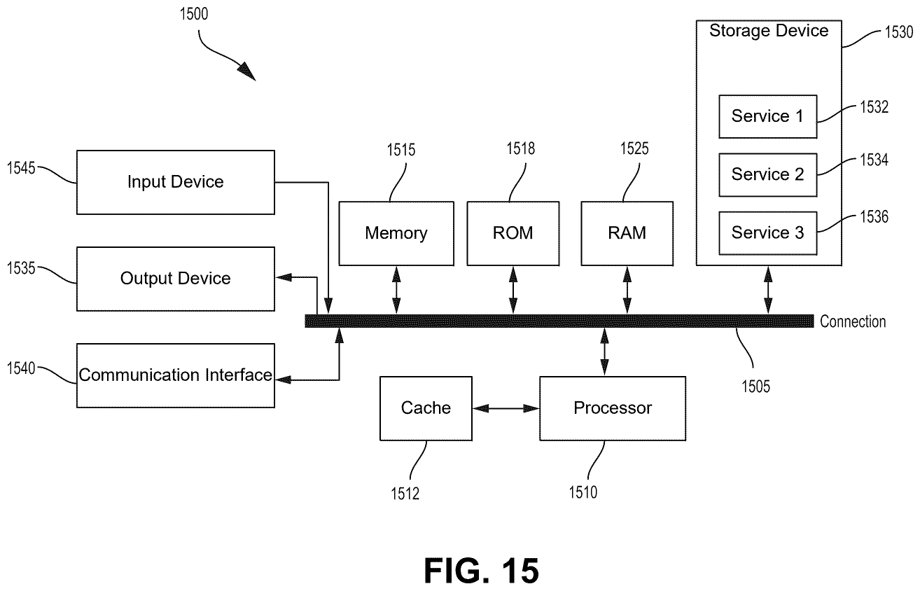

FIG. 14 is a flow chart illustrating an example of a process 1400 for 3D reconstruction assisted 3D Gaussian splatting. The process 1400 can be performed by a computing device (e.g., a computing device or computing system 1500 of FIG. 15) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 1400 may be implemented as software components that are executed and run on one or more processors (e.g., processor 1510 of FIG. 15, or other processor(s)). Further, the transmission and reception of signals by the computing device in the process 1400 may be enabled, for example, by one or more antennas and/or one or more transceivers (e.g., wireless transceiver(s)).

At block 1402, the computing device (or component thereof) can generate, based on image sensor pose information and depth information of a plurality of views of a scene, a three dimensional (3D) mesh of the scene. In some aspects, the computing device (or component thereof) can obtain, from one or more image sensors or using one or more image sensors of the computing device, the plurality of images of the scene from the plurality of views of the scene.

At block 1404, the computing device (or component thereof) can initialize a Gaussian splatting model based on the 3D mesh of the scene. The Gaussian splatting model includes a plurality of Gaussian splats. In some aspects, the 3D mesh includes a plurality of vertices forming a plurality of triangles that represent a plurality of surfaces within the scene. In such aspects, the plurality of Gaussian splats is positioned relative to the plurality of triangles.

In some cases, to initialize the Gaussian splatting model based on the 3D mesh of the scene, the computing device (or component thereof) can place a respective Gaussian splat of the plurality of Gaussian splats onto each triangle of the plurality of triangles. For instance, as described previously with respect to FIG. 9 and FIG. 10, the 3D mesh 1000 (or 3D simplified mesh or 3D dense mesh) can be used for initialization 930 of the Gaussian splats, a Gaussian splatting model can be initialized based on the 3D mesh 1000 of the scene. The Gaussian splatting model includes a plurality of Gaussian splats 940 positioned relative to the triangles of the 3D mesh 1000. The Gaussian splatting model can be initialized at least in part by placing a respective Gaussian splat onto each triangle of the 3D mesh 1000. In some aspects, for each chosen triangle in the 3D mesh 1000, a respective surface normal can be used to compute and guide the orientation and scale of a corresponding Gaussian splat to produce the plurality of 3D Gaussian splats 940.

Each respective Gaussian splat of the plurality of Gaussian splats includes a respective plurality of parameters corresponding to each view of the plurality of views of the scene. In some aspects, the respective plurality of parameters for each Gaussian splat includes a color, a location including three coordinates, an orientation, a respective scale (e.g., scale parameter) for each direction of three directions, an opacity, and/or other parameters. In some cases, the opacity for each Gaussian splat of the plurality of Gaussian splats is set to a fixed value. In some examples, the 3D mesh provides material information (e.g., associated with texture information) for each triangle of the plurality of triangles. In some cases, when the material information indicates an opaque material or a transparent material for a triangle of the plurality of triangles, the opacity parameter for a Gaussian splat corresponding to the triangle can be set to the fixed value. In some aspects, each Gaussian splat of the plurality of Gaussian splats includes three scale parameters (as an example of the respective scale parameter for each direction of the three directions). In one illustrative example, a first scale parameter of the three scale parameters is in a direction of a semi-major axis of the Gaussian splat, a second scale parameter of the three scale parameters is in a direction of a semi-minor axis of the Gaussian splat, and a third scale parameter of the three scale parameters is in a direction of a normal vector of a triangle of the plurality of triangles corresponding to the 3D mesh. In some cases, the third scale parameter is set to zero.

In some aspects, the computing device (or component thereof) can generate, based on sub-sampling the plurality of triangles of the 3D mesh, a simplified 3D mesh of the scene (e.g., as described with respect to FIG. 9). In some cases, the computing device (or component thereof) can generate, based on merging at least some triangles of the plurality of triangles together to generate a reduced set of triangles, a simplified 3D mesh of the scene (e.g., as described with respect to FIG. 9).

At block 1406, the computing device (or component thereof) can render, based on the initialized Gaussian splatting model, a plurality of rendered images of the scene corresponding to one or more views of the plurality of views of the scene.

At block 1408, the computing device (or component thereof) can update, based on a difference between the plurality of rendered images of the scene and a plurality of images of the scene, one or more parameters of the plurality of parameters of the Gaussian splatting model. In some aspects, to update the one or more parameters, the computing device (or component thereof) can determine a feedback error based on a difference between the plurality of rendered images of the scene and the plurality of images of the scene. In some cases, to update the one or more parameters, the computing device (or component thereof) can train, based on the feedback error, the Gaussian splatting model to tune the one or more parameters of the Gaussian splatting model.

In some cases, the computing device of process 1400 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1400 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1400 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1400 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a block diagram illustrating an example of a computing system 1500, which may be employed for 3D reconstruction assisted 3D Gaussian splatting. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some aspects, computing system 1500 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1500 includes at least one processing unit (CPU or processor) 1510 and connection 1505 that communicatively couples various system components including system memory 1515, such as read-only memory (ROM) 1518 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500.

Computing system 1500 can include communications interface 1540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1540 may also include one or more range sensors (e.g., LiDAR sensors, laser range finders, RF radars, ultrasonic sensors, and infrared (IR) sensors) configured to collect data and provide measurements to processor 1510, whereby processor 1510 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1540 may also include one or more receivers or transceivers that are used to determine a location of the computing system 1500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some aspects, a hardware service that performs a particular function can include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: generate, based on image sensor pose information and depth information of a plurality of views of a scene, a three dimensional (3D) mesh of the scene; initialize a Gaussian splatting model based on the 3D mesh of the scene, wherein the Gaussian splatting model comprises a plurality of Gaussian splats, and wherein each respective Gaussian splat of the plurality of Gaussian splats comprises a respective plurality of parameters corresponding to each view of the plurality of views of the scene; render, based on the initialized Gaussian splatting model, a plurality of rendered images of the scene corresponding to one or more views of the plurality of views of the scene; and update, based on a difference between the plurality of rendered images of the scene and a plurality of images of the scene, one or more parameters of the plurality of parameters of the Gaussian splatting model.

Aspect 2. The apparatus of Aspect 1, wherein the 3D mesh comprises a plurality of vertices forming a plurality of triangles that represent a plurality of surfaces within the scene, and wherein the plurality of Gaussian splats is positioned relative to the plurality of triangles.

Aspect 3. The apparatus of Aspect 2, wherein, to initialize the Gaussian splatting model based on the 3D mesh of the scene, the at least one processor is configured to place a respective Gaussian splat of the plurality of Gaussian splats onto each triangle of the plurality of triangles.

Aspect 4. The apparatus of Aspect 2, wherein the at least one processor is configured to generate, based on sub-sampling the plurality of triangles of the 3D mesh, a simplified 3D mesh of the scene.

Aspect 5. The apparatus of any of Aspects 2 to 4, wherein the at least one processor is configured to generate, based on merging at least some triangles of the plurality of triangles together to generate a reduced set of triangles, a simplified 3D mesh of the scene.

Aspect 6. The apparatus of any of Aspects 2 to 5, wherein each Gaussian splat of the plurality of Gaussian splats comprises three scale parameters, wherein a first scale parameter of the three scale parameters is in a direction of a semi-major axis of the Gaussian splat, wherein a second scale parameter of the three scale parameters is in a direction of a semi-minor axis of the Gaussian splat, and wherein a third scale parameter of the three scale parameters is in a direction of a normal vector of a triangle of the plurality of triangles corresponding to the 3D mesh, and the third scale parameter is set to zero.

Aspect 7. The apparatus of any of Aspects 2 to 6, wherein the 3D mesh provides material information for each triangle of the plurality of triangles, and wherein the material information is associated with texture information.

Aspect 8. The apparatus of Aspect 7, wherein, when the material information indicates an opaque material or a transparent material for a triangle of the plurality of triangles, an opacity parameter for a Gaussian splat corresponding to the triangle is set to a fixed value.

Aspect 9. The apparatus of any of Aspects 1 to 8, wherein, to update the one or more parameters, the at least one processor is configured to determine a feedback error based on a difference between the plurality of rendered images of the scene and the plurality of images of the scene.

Aspect 10. The apparatus of Aspect 9, wherein, to update the one or more parameters, the at least one processor is configured to train, based on the feedback error, the Gaussian splatting model to tune the one or more parameters of the Gaussian splatting model.

Aspect 11. The apparatus of any of Aspects 1 to 10, wherein the respective plurality of parameters for each Gaussian splat comprises at least one of a color, a location comprising three coordinates, an orientation, a respective scale for each direction of three directions, or an opacity.

Aspect 12. The apparatus of Aspect 11, wherein the opacity for each Gaussian splat of the plurality of Gaussian splats is set to a fixed value.

Aspect 13. The apparatus of any of Aspects 1 to 12, further comprising obtaining, from one or more image sensors, the plurality of images of the scene from the plurality of views of the scene.

Aspect 14. A method for image processing, the method comprising: generating, based on image sensor pose information and depth information of a plurality of views of a scene, a three dimensional (3D) mesh of the scene; initializing a Gaussian splatting model based on the 3D mesh of the scene, wherein the Gaussian splatting model comprises a plurality of Gaussian splats, and wherein each respective Gaussian splat of the plurality of Gaussian splats comprises a respective plurality of parameters corresponding to each view of the plurality of views of the scene; rendering, based on the initialized Gaussian splatting model, a plurality of rendered images of the scene corresponding to one or more views of the plurality of views of the scene; and updating, based on a difference between the plurality of rendered images of the scene and a plurality of images of the scene, one or more parameters of the plurality of parameters of the Gaussian splatting model.

Aspect 15. The method of Aspect 14, wherein the 3D mesh comprises a plurality of vertices forming a plurality of triangles that represent a plurality of surfaces within the scene, and wherein the plurality of Gaussian splats is positioned relative to the plurality of triangles.

Aspect 16. The method of Aspect 15, wherein initializing the Gaussian splatting model based on the 3D mesh of the scene comprises placing a respective Gaussian splat of the plurality of Gaussian splats onto each triangle of the plurality of triangles.

Aspect 17. The method of Aspect 15, further comprising generating, based on sub-sampling the plurality of triangles of the 3D mesh, a simplified 3D mesh of the scene.

Aspect 18. The method of any of Aspects 15 to 17, further comprising generating, based on merging at least some triangles of the plurality of triangles together to generate a reduced set of triangles, a simplified 3D mesh of the scene.

Aspect 19. The method of any of Aspects 15 to 18, wherein each Gaussian splat of the plurality of Gaussian splats comprises three scale parameters, wherein a first scale parameter of the three scale parameters is in a direction of a semi-major axis of the Gaussian splat, wherein a second scale parameter of the three scale parameters is in a direction of a semi-minor axis of the Gaussian splat, and wherein a third scale parameter of the three scale parameters is in a direction of a normal vector of a triangle of the plurality of triangles corresponding to the 3D mesh, and the third scale parameter is set to zero.

Aspect 20. The method of any of Aspects 15 to 19, wherein the 3D mesh provides material information for each triangle of the plurality of triangles, and wherein the material information is associated with texture information.

Aspect 21. The method of Aspect 20, wherein, when the material information indicates an opaque material or a transparent material for a triangle of the plurality of triangles, an opacity parameter for a Gaussian splat corresponding to the triangle is set to a fixed value.

Aspect 22. The method of any of Aspects 14 to 21, wherein updating the one or more parameters comprises determining a feedback error based on a difference between the plurality of rendered images of the scene and the plurality of images of the scene.

Aspect 23. The method of Aspect 22, wherein updating the one or more parameters comprises training, based on the feedback error, the Gaussian splatting model to tune the one or more parameters of the Gaussian splatting model.

Aspect 24. The method of any of Aspects 14 to 23, wherein the respective plurality of parameters for each Gaussian splat comprises at least one of a color, a location comprising three coordinates, an orientation, a respective scale for each direction of three directions, or an opacity.

Aspect 25. The method of Aspect 24, wherein the opacity for each Gaussian splat of the plurality of Gaussian splats is set to a fixed value.

Aspect 26. The method of any of Aspects 14 to 25, further comprising obtaining, by one or more image sensors, the plurality of images of the scene from the plurality of views of the scene.

Aspect 27. A non-transitory computer-readable medium having stored thereon instructions that, when executed by at least one processor, cause the at least one processor to perform operations according to any of Aspects 14 to 26.

Aspect 28. An apparatus for image processing, the apparatus including one or more means for performing operations according to any of Aspects 14 to 26.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
generate, based on image sensor pose information and depth information of a plurality of views of a scene, a three dimensional (3D) mesh of the scene;
initialize a Gaussian splatting model based on the 3D mesh of the scene, wherein the Gaussian splatting model comprises a plurality of Gaussian splats, and wherein each respective Gaussian splat of the plurality of Gaussian splats comprises a respective plurality of parameters corresponding to each view of the plurality of views of the scene;
render, based on the initialized Gaussian splatting model, a plurality of rendered images of the scene corresponding to one or more views of the plurality of views of the scene; and
update, based on a difference between the plurality of rendered images of the scene and a plurality of images of the scene, one or more parameters of the plurality of parameters of the Gaussian splatting model.

2. The apparatus of claim 1, wherein the 3D mesh comprises a plurality of vertices forming a plurality of triangles that represent a plurality of surfaces within the scene, and wherein the plurality of Gaussian splats is positioned relative to the plurality of triangles.

3. The apparatus of claim 2, wherein, to initialize the Gaussian splatting model based on the 3D mesh of the scene, the at least one processor is configured to place a respective Gaussian splat of the plurality of Gaussian splats onto each triangle of the plurality of triangles.

4. The apparatus of claim 2, wherein the at least one processor is configured to generate, based on sub-sampling the plurality of triangles of the 3D mesh, a simplified 3D mesh of the scene.

5. The apparatus of claim 2, wherein the at least one processor is configured to generate, based on merging at least some triangles of the plurality of triangles together to generate a reduced set of triangles, a simplified 3D mesh of the scene.

6. The apparatus of claim 2, wherein each Gaussian splat of the plurality of Gaussian splats comprises three scale parameters, wherein a first scale parameter of the three scale parameters is in a direction of a semi-major axis of the Gaussian splat, wherein a second scale parameter of the three scale parameters is in a direction of a semi-minor axis of the Gaussian splat, and wherein a third scale parameter of the three scale parameters is in a direction of a normal vector of a triangle of the plurality of triangles corresponding to the 3D mesh, and the third scale parameter is set to zero.

7. The apparatus of claim 2, wherein the 3D mesh provides material information for each triangle of the plurality of triangles, and wherein the material information is associated with texture information.

8. The apparatus of claim 7, wherein, when the material information indicates an opaque material or a transparent material for a triangle of the plurality of triangles, an opacity parameter for a Gaussian splat corresponding to the triangle is set to a fixed value.

9. The apparatus of claim 1, wherein, to update the one or more parameters, the at least one processor is configured to determine a feedback error based on a difference between the plurality of rendered images of the scene and the plurality of images of the scene.

10. The apparatus of claim 9, wherein, to update the one or more parameters, the at least one processor is configured to train, based on the feedback error, the Gaussian splatting model to tune the one or more parameters of the Gaussian splatting model.

11. The apparatus of claim 1, wherein the respective plurality of parameters for each Gaussian splat comprises at least one of a color, a location comprising three coordinates, an orientation, a respective scale for each direction of three directions, or an opacity.

12. The apparatus of claim 11, wherein the opacity for each Gaussian splat of the plurality of Gaussian splats is set to a fixed value.

13. The apparatus of claim 1, further comprising obtaining, from one or more image sensors, the plurality of images of the scene from the plurality of views of the scene.

14. A method for image processing, the method comprising:
generating, based on image sensor pose information and depth information of a plurality of views of a scene, a three dimensional (3D) mesh of the scene;
initializing a Gaussian splatting model based on the 3D mesh of the scene, wherein the Gaussian splatting model comprises a plurality of Gaussian splats, and wherein each respective Gaussian splat of the plurality of Gaussian splats comprises a respective plurality of parameters corresponding to each view of the plurality of views of the scene;
rendering, based on the initialized Gaussian splatting model, a plurality of rendered images of the scene corresponding to one or more views of the plurality of views of the scene; and
updating, based on a difference between the plurality of rendered images of the scene and a plurality of images of the scene, one or more parameters of the plurality of parameters of the Gaussian splatting model.

15. The method of claim 14, wherein the 3D mesh comprises a plurality of vertices forming a plurality of triangles that represent a plurality of surfaces within the scene, and wherein the plurality of Gaussian splats is positioned relative to the plurality of triangles.

16. The method of claim 15, wherein initializing the Gaussian splatting model based on the 3D mesh of the scene comprises placing a respective Gaussian splat of the plurality of Gaussian splats onto each triangle of the plurality of triangles.

17. The method of claim 15, further comprising generating, based on sub-sampling the plurality of triangles of the 3D mesh, a simplified 3D mesh of the scene.

18. The method of claim 15, wherein each Gaussian splat of the plurality of Gaussian splats comprises three scale parameters, wherein a first scale parameter of the three scale parameters is in a direction of a semi-major axis of the Gaussian splat, wherein a second scale parameter of the three scale parameters is in a direction of a semi-minor axis of the Gaussian splat, and wherein a third scale parameter of the three scale parameters is in a direction of a normal vector of a triangle of the plurality of triangles corresponding to the 3D mesh, and the third scale parameter is set to zero.

19. The method of claim 18, wherein the 3D mesh provides material information for each triangle of the plurality of triangles, and wherein, when the material information indicates an opaque material or a transparent material for a triangle of the plurality of triangles, an opacity parameter for a Gaussian splat corresponding to the triangle is set to a fixed value.

20. The method of claim 14, wherein the respective plurality of parameters for each Gaussian splat comprises at least one of a color, a location comprising three coordinates, an orientation, a respective scale for each direction of three directions, or an opacity, wherein the opacity for each Gaussian splat of the plurality of Gaussian splats is set to a fixed value.
